(19) United States
(12) Patent Application Publication
(10) Pub. No.: US 2023/0092798 A1
(43) Pub. Date: Mar. 23, 2023

(54) ENERGY COLLECTION DEVICE, SYSTEM AND METHOD

(71) Applicant: Charles Norton, Naylor, GA (US)

(72) Inventor: Charles Norton, Naylor, GA (US)

(21) Appl. No.: 17/951,029

(22) Filed: Sep. 22, 2022

Related U.S. Application Data
(60) Provisional application No. 63/247,114, filed on Sep. 22, 2021.

(51) Int. Cl. F03D 9/11

(52) U.S. Cl. CPC F03D 9/11; F05B 2220/604

(57) ABSTRACT

An energy collection system for capturing wind energy being exhausted from an air exhaust system. The energy collection system has a frame and a wind turbine. The wind turbine has a blade configured to rotate about a shaft. Air leaving the air exhaust system in a vertical direction causes the blade to rotate which is then converted by the wind turbine into electricity.

### CROSS-REFERENCE TO RELATED APPLICATIONS

This application claims the benefit of and priority to U.S. Provisional Patent 63/247,114, filed Sep. 22, 2021, which is incorporated in its entirety in this document by reference.

### FIELD OF THE INVENTION

The present invention relates generally to energy collection devices, systems and methods. More specifically, the invention pertains to devices, systems and methods for collecting energy being exhausted from an air exhaust system such as a heating, ventilation and air conditioning system.

### BACKGROUND OF THE INVENTION

Most residential and commercial heating, ventilation and air conditioning (“HVAC”) systems include a condenser unit. A fan in the condenser unit blows air over coils in order to either collect or release heat. For example, in the summer, heat from inside a building is released to the atmosphere when the condenser fan moves air over coils. Typically, the fan is pointed up so that air discharged from the fan moves vertically away from the condenser.

Accordingly, it is desirable to collect kinetic energy created by the movement of air to generate electricity and/or to improve the efficiency of the HVAC system. However, conventional wind turbines are configured to be rotated by air moving horizontally. Moreover, air being moved by the fan of the condenser is usually not moved fast enough to effectively rotate a wind turbine.

What is needed then is a device, system and method to collect kinetic energy of the moving air from an air exhaust system, such as an HVAC system having a condenser.

### SUMMARY

Presented herein is an energy collection system for capturing wind energy being exhausted from an air exhaust system such as an HVAC system and the like. In use, air exiting the air exhaust system can be directed to the wind turbine so that the wind turbine can capture a portion of the kinetic energy in the moving air. For example, if the air exiting the air exhaust system is moving vertically, the wind turbine can be configured to capture at least a portion of the kinetic energy in the vertically moving air.

The energy collection system can comprise a frame and a wind turbine coupled to the frame. The frame can be sized and shaped so that the wind turbine is a predetermined distance from the air exhaust system. The wind turbine can comprise at least one blade coupled to a rotatable shaft. In one aspect, the blade can be configured to rotate about the shaft when air is moving in a direction substantially parallel to the shaft. For example, air moving vertically away from the air exhaust system can cause the blade to rotate about an axis parallel to the direction of air movement.

In use, a fan of the air exhaust system can move air away from the air exhaust system vertically and towards the wind turbine. The air can contact the blade of the wind turbine which can cause the blade to rotate. The rotational energy of the blade can then be converted by the wind turbine into electricity.

Related methods of operation are also provided. Other apparatuses, methods, systems, features, and advantages of the energy collection system will be or become apparent to one with skill in the art upon examination of the following figures and detailed description. It is intended that all such additional apparatuses, methods, systems, features, and advantages be included within this description, be within the scope of the energy collection system and be protected by the accompanying claims.

### DESCRIPTION OF THE FIGURES

FIG. 1 is a perspective view of an energy collection system coupled to an air exhaust system, according to one aspect;

FIG. 2 is a top view of the energy collection system of FIG. 1;

FIG. 3 is a side view of the energy collection system of FIG. 1; and

FIG. 4 is a side view of the energy collection system of FIG. 1, according to one aspect.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “element” includes aspects having two or more such elements unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint and independently of the other endpoint.

As used herein, the terms “optional” or “optionally” mean that the subsequently described event or circumstance may or may not occur, and that the description includes instances where said event or circumstance occurs and instances where it does not.

As used herein, the terms “vertical” or “vertically” when used in reference to moving air mean that the air is moving in a generally vertical direction that is parallel to the force of gravity. It is understood that some portion of the moving air will have a horizontal component of movement in addition to a vertical component. However, “vertical” and “vertically” as used herein mean that taken as a whole, the general direction of the air is parallel to the force of gravity.

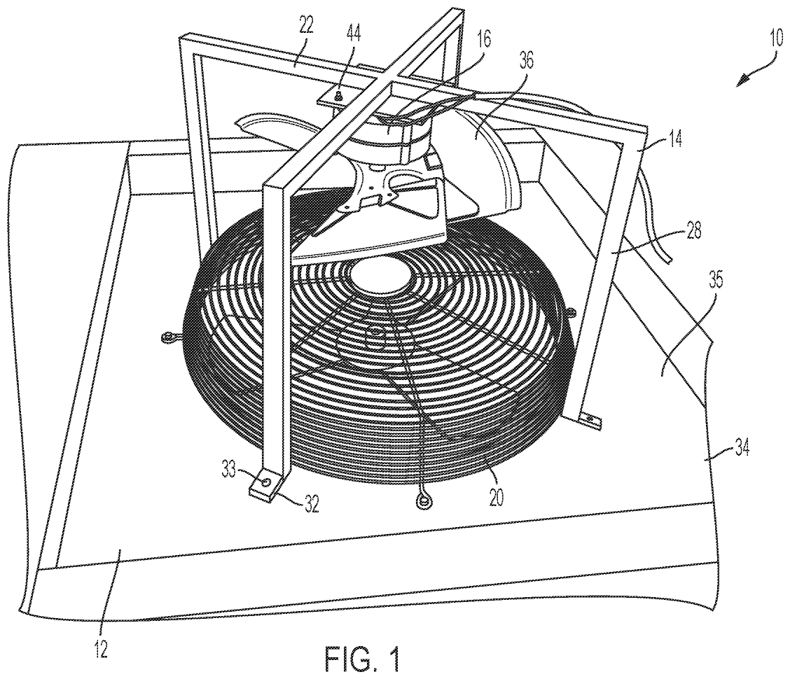

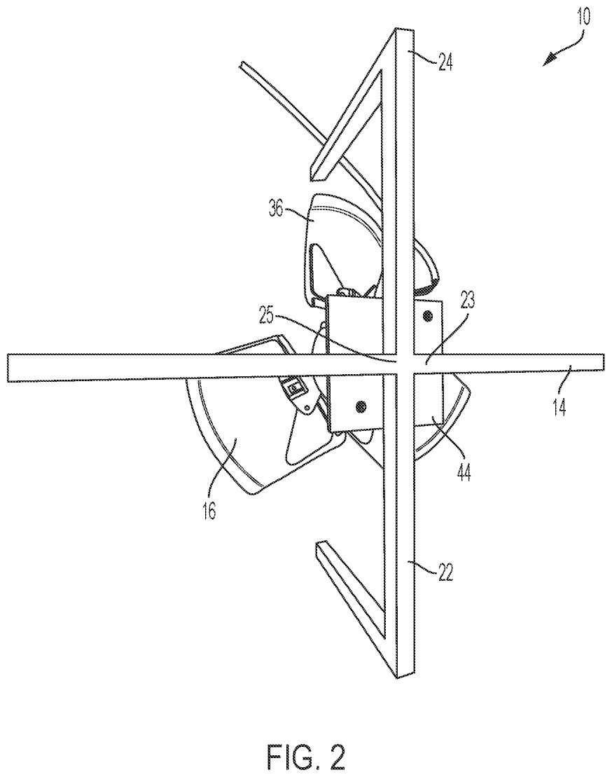

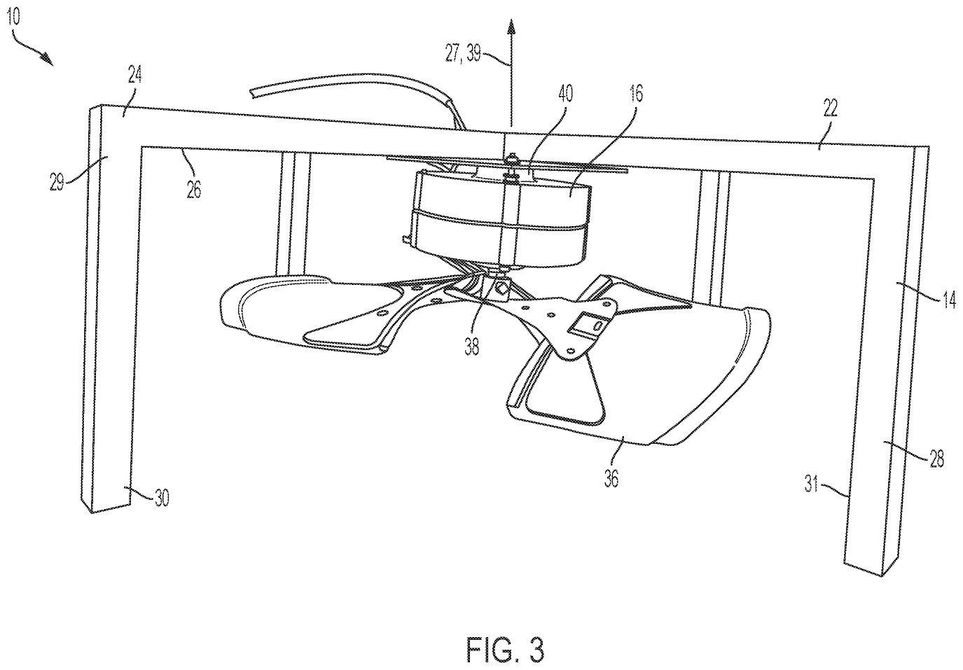

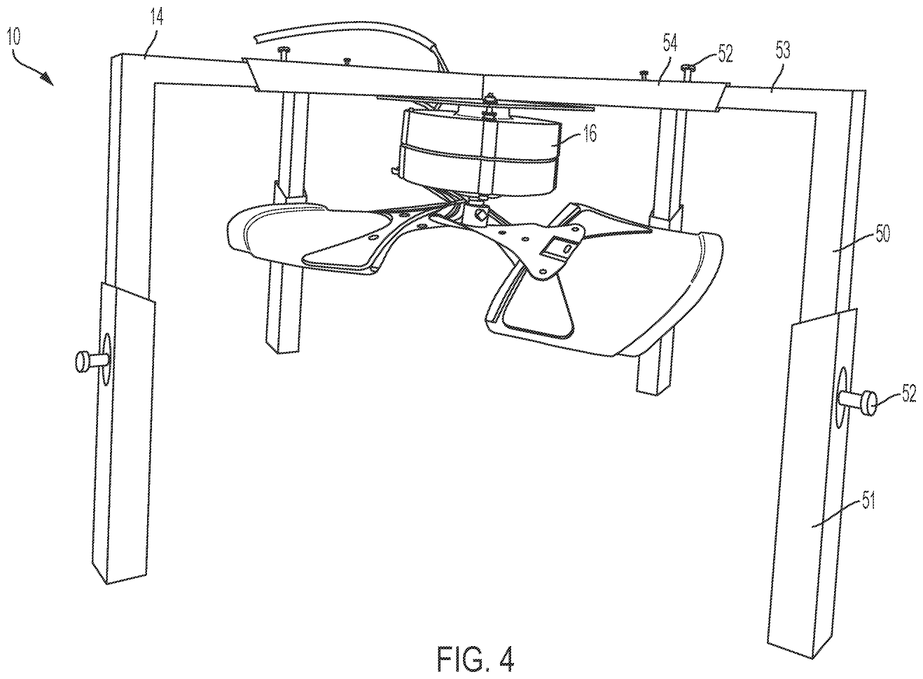

Referring now to FIGS. 1-4, the energy collection system 10 for collecting energy being exhausted from an air exhaust system 12 can comprise a frame 14 positioned adjacent to a portion of the air exhaust system 12 and a wind turbine 16 coupled to the frame 14. In use, air exiting the air exhaust system 12 can be directed to the wind turbine 16 so that the wind turbine 16 can capture a portion of the kinetic energy in the moving air by converting the kinetic energy into electrical energy. For example, if the air exhaust system 12 exhausts air upwards vertically, the wind turbine 16 can be positioned above the air exhaust system 12 so that the wind turbine 16 can capture a portion of the kinetic energy in the upward vertically moving air.

The air exhaust system 12 can be any system that has a fan 20 configured to move air away from the air exhaust system 12. For example and without limitation, the air exhaust system 12 can be a heating, ventilation, and/or air conditioning (“HVAC”) system such as a small residential HVAC system, a very large commercial HVAC system or any system in between the two.

The frame 14 can be configured to space the wind turbine 16 a predetermined turbine distance from the fan 20 of the air exhaust system 12. In one aspect, the frame 14 can be formed from rigid materials such as steel, aluminum, wood and the like. In another aspect, the frame 14 can comprise a plurality of arms 22, each arm 22 having a proximal end 23 and an opposed distal end 24. The proximal end 23 of each arm 22 can be coupled together to form a frame center 25 so that the distal end 24 of each arm 22 extends away from the frame center 25 a predetermined arm distance.

In yet another aspect, a first arm surface 26 of each arm 22 can be positioned in a plane that is substantially normal to the direction of the moving air. For example, if the air exhaust system 12 exhausts air upwards in a vertical manner along an exhaust longitudinal axis 27, the first arm surface 26 can be positioned in a plane that is substantially at a right angle to the exhaust longitudinal axis 27. Alternatively, the first arm surface 26 of each arm 22 can be positioned in a plane that is at an acute angle relative to the direction of the moving air. For example, if the air exhaust system 12 exhausts air upwards in a vertical manner along the exhaust longitudinal axis 27, the first arm surface 26 can be positioned in a plane that is at an acute angle relative to the exhaust longitudinal axis 27.

In one aspect, each arm 22 can have substantially the same arm length. Alternatively, however, at least one arm 22 of the plurality of arms 22 can have a different length than an adjacent arm 22. In another aspect, at least one arm 22 of the plurality of arms 22 can have an adjustable arm length so that a user of the energy collection system 10 can select a desired arm length. For example, a first arm portion 53 can be configured to slide telescopically within a second arm portion 54. A set screw 52, a clamp and the like can be used to secure the first arm portion 53 in the desired position relative to the second arm portion 54. In this aspect, the arm length can be adjusted about and between a first arm length and a second arm length that is greater than the first arm length.

The frame 14 can further comprise a plurality of legs 28, each leg 28 having a proximal end 29 and an opposed distal end 30. The proximal end 29 of each leg 28 can be coupled to a distal end 24 of an arm 22 so that the distal end 30 of each leg 28 extends away from the arm 22 a predetermined leg distance. In yet another aspect, a first leg surface 31 of each leg 28 can be positioned in a plane that is substantially parallel to the direction of the moving air. For example, if the air exhaust system 12 exhausts air upwards in a vertical manner along the exhaust longitudinal axis 27, the first leg surface 31 can be positioned in a plane that is substantially parallel to the exhaust longitudinal axis 27. Alternatively, the first leg surface 31 of each leg 28 can be positioned in a plane that is at an acute angle relative to the direction of the moving air. For example, if the air exhaust system 12 exhausts air upwards in a vertical manner along the exhaust longitudinal axis 27, the first leg surface 31 can be positioned in a plane that is at an acute angle relative to the exhaust longitudinal axis 27.

In one aspect, each leg 28 can have substantially the same leg length. Alternatively, however, at least one leg 28 of the plurality of legs 28 can have a different length than an adjacent leg 28. In another aspect, at least one leg 28 of the plurality of legs 28 can have an adjustable leg length so that a user of the energy collection system 10 can select a desired leg length. For example, a first leg portion 50 can be configured to slide telescopically within a second leg portion 51. A set screw 52, a clamp and the like can be used to secure the first leg portion 50 in the desired position relative to the second leg portion 51. In this aspect, the leg length can be adjusted about and between a first leg length and a second leg length that is greater than the first leg length.

The frame 14 can further comprise a means for secured attachment to the air exhaust system 12 and/or to the wind turbine 16. For example, a flange 32 can extend from the arm 22 and/or the leg 28 of the frame 14. At least one hole 33 can be defined in the flange 32 so that the frame 14 can be fixedly attached to the air exhaust system 12 and/or to the wind turbine 16 with bolts, screws and the like. In another example, the frame 14 can be fixedly welded to the air exhaust system 12 and/or to the wind turbine 16. In still another example, the frame 14 can be fixedly bonded to the air exhaust system 12 and/or to the wind turbine 16 with adhesives and the like. In one aspect, the frame 14 can be fixedly attached directly to a substantially flat upper surface 34 of the air exhaust system 12.

Optionally, it is contemplated that at least a portion of the frame 14 can be formed integrally with the air exhaust system 12. For example, the frame 14 can be formed as part of an air exhaust housing 35 of the air exhaust system 12. That is, instead of having the substantially flat upper surface 34 as shown in FIG. 1, a portion of the air exhaust housing 35 can extend upwards from the upper surface 34 to form at least a portion of the frame 14.

The wind turbine 16 can comprise at least one blade 36 coupled to a rotatable shaft 38. In one aspect, the at least one blade 36 can be sized and shaped to rotate around a longitudinal axis 39 of the shaft 38 when air is moving in a direction substantially parallel to the longitudinal axis of the shaft 38. That is, the blade 36 can be curved and dimensioned so that air moving upwards vertically causes the blade 36 to rotate relative to the shaft 38. For example, air moving away from the air exhaust system 12 in an upward vertical manner along the exhaust longitudinal axis 27 can cause the blade 36 to rotate around the longitudinal axis 39 of the shaft 38. In one aspect, the longitudinal axis 39 of the shaft 38 can be substantially parallel the exhaust longitudinal axis 27. In another aspect, the at least one blade 36 can be sized and shaped to rotate around the longitudinal axis 39 of the shaft 38 when air is moving in a direction at an acute angle relative to the longitudinal axis 39 of the shaft 38 and/or the exhaust longitudinal axis 27.

In another aspect, the at least one blade 36 can comprise a plurality of blades 36. For example, the at least one blade 36 can comprise two, three, four, five, six, seven, eight, nine, ten or more than ten blades. Each blade 36 of the plurality of blades 36 can have the same shape and size. Alternatively, at least one blade 36 can have a different size and/or shape than an adjacent blade 36. That is, in order to rotate most efficiently, each blade 36 of the plurality of blades 36 can have the same shape and size, or at least one blade 36 of the plurality of blades 36 can have a different shape and size. In one aspect, the at least one blade 36 can have a blade diameter that is substantially equal to, less than or greater than a diameter of the fan 20 of the air exhaust system 12.

The wind turbine 16 can further comprise a proximal base 40 configured to couple the wind turbine 16 to the frame 14 and/or the air exhaust system 12. In one aspect, at least one elongate mounting bar or plate 44 can be fixedly attached to the first arm surface 26 of the frame 14 such that the mounting bar or plate 44 is positioned above at least a portion of the fan 20. After attachment of the at least one mounting bar or plate 44 to the air exhaust system 12, the base 40 of the wind turbine 16 can be fixedly attached to the mounting bar or plate 44 so that the at least one blade 36 is rotatably coupled to the mounting bar or plate 44 at a position above at least a portion of the fan 20.

According to some aspects, the energy collection system 10 can further comprise a shroud or grill (not shown) configured to at least partially enclose the rotating blade 36 of the wind turbine. For example, the grill can be a rigid cage that allows air to pass through, but prevents or restrictions the insertion of other objects, such as fingers, leaves and the like that could be damaged by the blade 36 and/or could do damage to the blade 36.

To assemble the energy collection system 10, the frame 14 can be coupled to the upper surface 34 of the air exhaust housing 35. In one aspect, the frame 14 can be directly attached to the upper surface 34 of the air exhaust system 12, while in other aspects, the frame 14 can be spaced from the upper surface 34 a predetermined distance with the use of spacers. The at least one elongate mounting bar or plate 44 can be fixedly attached to the frame 14, and the wind turbine 16 can be coupled to the mounting bar or plate 44. Once assembled, the fan 20 of the air exhaust system 12 can be in fluid communication with the blade 36 of the wind turbine 16.

Note that the length of each leg 28 can be selected so that when assembled, the fan 20 of the air exhaust system 12 is a predetermined turbine distance from the closest portion of the at least one blade 36. In one aspect, the predetermined turbine distance can be about 1 inch, about 2 inches, about 3 inches, about 4 inches, about 5 inches, about 6 inches, about 7 inches, about 8 inches, about 9 inches, about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, or more than 24 inches. In one aspect, the predetermined turbine distance can be greater than a diameter of the fan 20 of the air exhaust system 12. Alternatively, in some aspects, the predetermined turbine distance can be substantially equal to or even less than a diameter of the fan 20 of the air exhaust system 12

In use, the fan 20 of the air exhaust system 12 can rotate to cause air to move upwards and away from the air exhaust system 12 in a generally vertical direction towards the wind turbine 16. As vertically moving air departs the air exhaust system 12, the air can contact the blade 36 of the wind turbine 16 which can cause the blade 36 to rotate. The rotational energy of the blade 36 can be converted by the wind turbine 16 into electricity.

With a conventional air exhaust system 12, the kinetic energy of the vertically moving air being exhausted from the air exhaust system 12 is lost to the atmosphere. By coupling the energy collection system 10 of the present application to the air exhaust system 12, at least a portion of this energy that is normally lost can be captured. For example, about 1%, about 2%, about 3%, about 4%, about 5%, about 10%, about 20%, about 30%, about 40%, about 50% or more than about 50% of the energy that is normally lost to the atmosphere can be collected. This collected electricity can be used to improve the efficiency of the air exhaust system 12, be stored in a battery for later use, and/or be transmitted to an additional electric device.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. An energy collection system for collecting energy in moving air exhausted from an air exhaust system, the energy collection system comprising:
a frame positioned adjacent to a portion of the air exhaust system; and
a wind turbine coupled to the frame, the wind turbine comprising at least one blade coupled to a rotatable shaft,
wherein the air exhausted from the air exhaust system is moving in a vertical direction, wherein the vertically moving air causes the at least one blade to rotate, and wherein the wind turbine creates electricity upon rotation of the at least one blade.

2. The energy collection system of claim 1, wherein the frame comprises a plurality of legs, and wherein each leg has a leg length so that a fan of the air exhaust system is a predetermined turbine distance from the closest portion of the at least one blade.

3. The energy collection system of claim 2, wherein the leg length is selectively adjustable about and between a first leg length and a second leg length that is greater than the first leg length.

4. The energy collection system of claim 2, wherein the predetermined turbine distance is greater than a diameter of the fan of the air exhaust system.

5. The energy collection system of claim 1, wherein electricity created by the wind turbine improves the efficiency of the air exhaust system.

6. The energy collection system of claim 1, wherein about 1% of kinetic energy in the vertically moving air that is normally lost to the atmosphere is collected by the wind turbine.

7. The energy collection system of claim 1, wherein the at least one blade rotates about an axis parallel to the direction of air movement.

8. A method of collecting energy being exhausted from an air exhaust system, the method comprising:
providing a frame and positioning the frame adjacent to a portion of the air exhaust system;
providing a wind turbine and securely attaching the wind turbine to the frame, the wind turbine comprising at least one blade coupled to a rotatable shaft, wherein air exhausted from the air exhaust system is moving in a vertical direction, wherein the vertically moving air causes the at least one blade to rotate, and wherein the wind turbine creates electricity upon rotation of the at least one blade; and
electrically coupling the wind turbine to a battery.

9. The energy collection method of claim 8, wherein the frame comprises a plurality of legs, and wherein each leg has a leg length so that a fan of the air exhaust system is a predetermined turbine distance from the closest portion of the at least one blade.

10. The energy collection method of claim 9, wherein the leg length is selectively adjustable about and between a first leg length and a second leg length that is greater than the first leg length.

11. The energy collection method of claim 9, wherein the predetermined turbine distance is greater than a diameter of the fan of the air exhaust system.

12. The energy collection method of claim 8, wherein electricity created by the wind turbine improves the efficiency of the air exhaust system.

13. The energy collection method of claim 8, wherein about 1% of kinetic energy in the vertically moving air that is normally lost to the atmosphere is collected by the wind turbine.
